(19) United States
(12) Patent Application Publication
(10) Pub. No.: US 2010/0163490 A1
(43) Pub. Date: Jul. 1, 2010

(54) MODULAR CHROMATOGRAPHY DEVICE

(75) Inventor: Alain Lasalle, Vaudoeuvre-Les-Nancy (FR)

Correspondence Address: MARSH, FISCHMANN & BREYFOGLE LLP, 8055 East Tufts Avenue, Suite 450, Denver, CO, 80237, US

(73) Assignee: NOVASEP, Pompey (FR)

(21) Appl. No.: 12/280,914

(22) PCT Filed: Mar. 2, 2007
(86) PCT No.: PCT/FR2007/000376

§ 371 Date: Aug. 27, 2008

(30) Foreign Application Priority Data
Mar. 3, 2006 (FR) 0601907

(51) Int. Cl. B01D 15/08; B65B 1/24

(52) U.S. Cl. 210/656; 210/198.2; 141/12

(57) ABSTRACT

The subject of the invention is a chromatography device comprising: (i) a unit column intended to receive a chromatographic bed, (ii) a removable reservoir for a bed slurry, and (iii) a base comprising a cylinder adapted to a piston, said piston sliding in the removable reservoir and the column to compress the slurry of solid particles into a chromatographic bed; the column, reservoir and base being connected in series in this order, the piston acting to compress the slurry of solid particles into a chromatographic bed in the column.

A further subject of the invention is a column for use in the device, a method to pack a chromatographic bed and a separation method using the device or the column.

### FIELD OF THE INVENTION

The present invention relates to a novel device for high performance preparative chromatography which combines packing of the chromatographic bed and use of the chromatography column.

### TECHNOLOGICAL BACKGROUND

With a chromatographic separation process, the efficacy of the column used is a key parameter. The column is generally packed with a solid product called the stationary phase in the form of very fine particles of usual size between 5 and 100 μm for high performance chromatography systems, forming the chromatographic bed. To achieve high efficacy, the arrangement of the particles inside the column must be as homogeneous as possible, and additionally provision must be made to eliminate voids between the chromatographic bed and the column inlet, voids inside the bed or channelling inside the chromatographic bed subsequent to rearrangement of the particles during elution on the column and related to poor initial organisation of the chromatographic bed when packing the column. In the prior art, it is known to have recourse to Dynamic Axial Compression columns to ensure a compact, homogeneous bed, free of voids. The solvents used can be in the liquid, supercriticial or subcriticial state.

Dynamic Axial Compression (DAC) columns have a sliding piston or other body moved by a cylinder actuated by an independent hydraulic circuit for example; the sliding body is used to pack the lining in a chamber between this piston and a fixed bottom part ore removable cap. The sliding body enters into contact with the solid phase to maintain constant mechanical pressure on the bed.

From French patent application FR-A-2 219 797, chromatographic apparatus is known in the form of a column intended to a contain a bed of adsorbent material. The apparatus consists of a tube comprising a cap and a body sliding within the tube to exert pressure inside the tube. The sliding body is a piston having at its head a porous plate that is permeable to fluids, called a frit. To obtain the bed for chromatography, a suspension of particles of a material able to form an adsorbent bed is added to the tube after removing its cap or piston. The cap is placed on the tube, then pressure is exerted on said suspension by means of the piston or sliding body. The liquid is expelled through the porous plates, and said particles are compressed between the piston and the cap. In one example of embodiment, this apparatus can obtain the chosen bed compression and the desired particle packing when the sliding body has generally traveled over between ¼ and ¾ of the height of the column, depending on the density of the suspension used to pack the column.

There are alternatives to this DAC system through the use of a dedicated compression module. These modular systems include (i) an axial compression module dedicated to packing of the suspension into a bed, and (ii) a chromatography column equipped with a piston to ensure homogeneous packing of the column via axial compression, a compression which is nevertheless not maintained on the bed when the chromatographic column is used, unlike DAC columns.

For example, the Merck Selfpacker system is known whose packing protocol is described below. The column must be mounted with the piston on the hydraulic compression system using screws. Once the upper flange of the column has been removed, a packing reservoir is fixed above the column. The suspension is added to the reservoir and column from the top, the system is kept open. A vacuum is applied to the line for 5 to 45 minutes through to the outlet of the lower flange, to cause formation of the bed of particles by aspirating liquid through the output frit of the column (at the lower level). The reservoir is then removed, the column is closed by a flange system secured by screws, optionally a solvent is injected, and the bed is placed under pressure by moving the piston from bottom to top inside the column. After compression, the column is disconnected from the hydraulic system after locking the piston with a threaded rod. The application of a vacuum is a very time-consuming operation.

The Modcol system is also known, in which this time compressive force is exerted from top to bottom, but with no prior vacuum application. The column heights are necessarily longer than in the above-cited Merck case since the columns must contain the suspension before compression. After compression, the piston is locked in placed by a threaded rod. A mechanical spring system can be used to maintain compressive force on the bed. The Modcol technology uses elements which need to be screwed together.

The Amicon system loads the suspension in a system comprising a column and an adjustment unit, this unit being used in particular as reservoir for loading the particle suspension. After loading the suspension, an adaptor is secured to the body of the column, an adaptor which this time contains the piston, and packing can be achieved downwardly in a press. The pressure is then released, the adaptor is removed and the piston is held in position by a safety system in the adjustment unit which is not removable and remains secured to the column.

The Axxial system uses two opposing pistons which compress the bed in the column which is located in the centre of the system. The use of two pistons (without any possible subsequent recompression of the column) is complex.

Document JP 61283278 describes a method to compress a load in order to obtain a chromatographic bed. Two columns, one lower and one upper, are used end to end, a piston being positioned at the free end of each column. The load is placed in the lower column and the piston pushes the load towards the upper column; the lower column is then removed and a flange is positioned at the lower end of the upper column. It is noted that the piston of the lower column does not enter into the upper column. The piston of the upper column is then actuated to pack the load against the flange.

This document has the disadvantage of requiring two pistons, one of the pistons transferring the load from the lower column to the upper column, the other piston packing the loads in the upper column. Also, removal of the lower column to place the flange in position is precarious, the lower end of the load being exposed to open air while the flange is placed in position. This method therefore does not perform well.

Document JP 63288138 describes a method to compress a load to obtain a chromatographic bed. A piston is actuated to pack the load in a column; a cone between the piston and the column allows adaptation of the piston size to the diameter of the column, the column diameter being smaller than the piston diameter. It is noted that the piston cannot enter into the column since the piston diameter is greater than the column diameter. Once the load has been packed in the column to form the bed, the column is removed.

This document has several drawbacks. First it is noted that removal of the column entails risks; the upper end of the load is exposed to open air once the column has been removed from the cone. Also, once the column is removed it is not described in this document how to maintain packing of the bed. This method does not therefore give good performance.

There is therefore a need for a modular chromatography system enabling problems encountered with current systems to be avoided, and in particular which allows quick loading and compressing of the bed in compact columns so that their size can be reduced.

### SUMMARY OF THE INVENTION

The subject-matter of the present invention is a modular chromatography system.

The invention therefore provides a chromatography device comprising:
a single unit column intended to receive a chromatographic bed,
a removable reservoir for bed suspension,
a base comprising a cylinder adapted to a piston, said piston sliding within the removable reservoir and the column to compress the suspension of solid particles into a chromatographic bed,
the column, reservoir and base being connected in series in this order, the piston acting to compress the suspension of solid particles into a chromatographic bed in the column.

According to one embodiment, the column, reservoir and base are connected from top to bottom.

According to one embodiment, the piston is equipped with a piston seal entering with friction in the column and in the reservoir.

According to one embodiment, the piston and cylinder are connected by a coupling cylinder and optionally a set of anti-rotation gaskets reversibly bearing upon the piston.

According to one embodiment, the column, reservoir, and base are secured to flanges via clamping rings.

According to one embodiment, the base comprises two chambers receiving pressurized hydraulic fluid, arranged at each side of the lower part of the cylinder.

According to one embodiment, the column also comprises an assembly of threaded rod and tapped flange receiving the threaded rod, said threaded rod adapting to the piston, this assembly substituting for the reservoir when the column is used as chromatography column.

A further subject of the invention is a chromatography column comprising an assembly of threaded rod and tapped flange receiving the threaded rod, said threaded rod adapting to the piston, this assembly being secured to the column via a clamping ring attachment.

A further subject of the invention is a chromatography column comprising an assembly of threaded rod and tapped flange receiving said threaded rod, said threaded rod adapting to the piston, this assembly being secured to the column, and in which the rod and flange threads are coated with an anti-seizure coating.

Yet a further subject of the invention is a method to pack a chromatographic bed inside a chromatographic column, comprising the following steps:
providing a chromatography device according to the invention
filling this device with a bed suspension;
causing translation of the cylinder and piston to compress the suspension into a bed.

According to one embodiment, the method also comprises the following step:
detaching the column from the reservoir.

According to one embodiment, the method also comprises the following step:
associating the assembly of threaded rod and tapped flange receiving the threaded rod, said threaded rod adapting to the piston.

According to one embodiment, the method also comprises a recompression step by clamping the threaded rod.

A further subject of the invention is a separation method to separate at least two compounds from a fluid to be chromatographied, comprising chromatography of said fluid in the column according to the invention.

A further subject of the invention is a method to separate at least two compounds from a fluid to be chromatographied, comprising the steps of packing of the bed according to the invention, and flow of the fluid to be chromatographied through the bed and collection thereof.

For the different subject-matters above, according to one embodiment, the threads of the rod and tapping are coated with an anti-seizure coating. The end of the rod can be machined to have hexagonal sides so as to receive a clamping wrench.

For the different subject-matters given above, according to one embodiment, a spring can be provided between said threaded rod and the piston.

### BRIEF DESCRIPTION OF THE DRAWINGS

Other characteristics and advantages of the invention will become apparent on reading the following detailed description of embodiments of the invention, given solely as examples and with reference to the drawings which show:

FIG. 1, a chromatography device according to the invention,

FIGS. 2a et 2b, an enlarged view of part of the chromatography device according to the invention,

FIGS. 3a and 3b, another embodiment

### DETAILED DESCRIPTION OF EMBODIMENTS OF THE INVENTION

The device described below can be used to conduct chromatography of a supercritical or subcritical fluid.

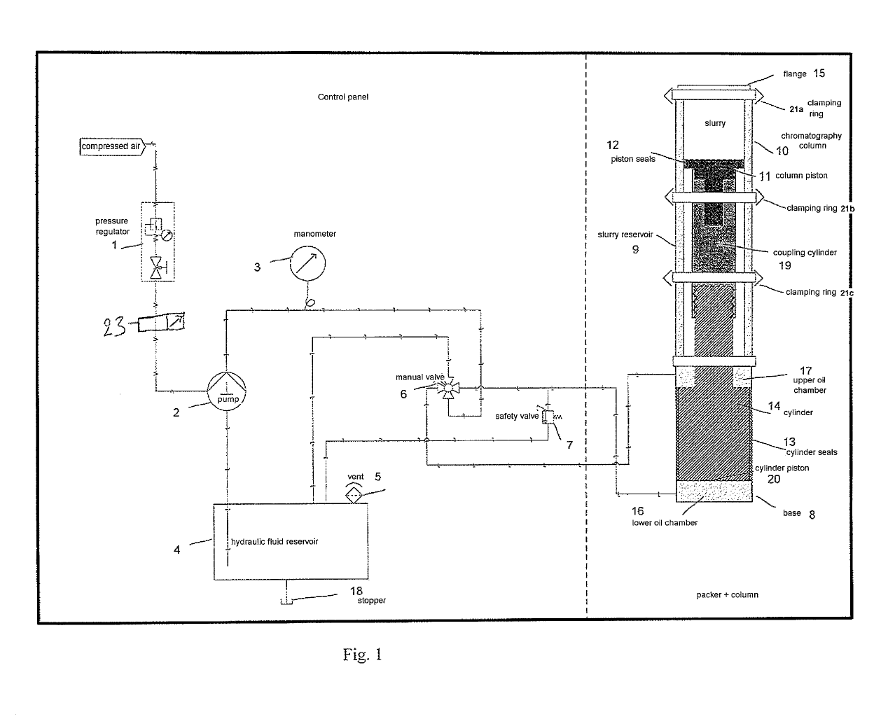

With reference to FIG. 1, the device comprises a modular system illustrated on the right-hand side of the figure, whilst the hydraulic system is illustrated on the left, a dotted line schematically separating the two parts.

The hydraulic system comprises a pressure regulator 1, a hydropneumatic pump 2, a manometer 3 and a reservoir 4 of hydraulic fluid, typically oil. The reservoir 4 is provided with a vent 5 and discharge outlet 18 for oil maintenance. A manual valve 6 is used to direct the oil towards the modular system, as indicated below. A safety valve 7 and an emergency stop button 23 complete the hydraulic system.

The modular system, during the packing phase of the suspension into a chromatographic bed, comprises the following elements: a column 10 closed in its upper part by a flange 15 secured by a clamping ring 21a, a removable reservoir 9 intended to receive the chromatographic bed suspension, and a base 8. A cylinder 14 is arranged in the base. It is adapted to a column piston 11 via a coupling cylinder 19. The coupling cylinder 19 is not joined to the column piston 11, but it transmits pressure from the cylinder 14 to the piston 11 which is therefore able to rise in the reservoir 9 and column 10 to compress the bed, or it can be lowered to release pressure on the piston 11 in relation to the position of valve 6.

Two hydraulic fluid chambers 16 and 17 are arranged at each side of the cylinder 14, the cylinder sliding in the base between the two chambers via a seal 13. The chambers 16 and 17 are defined by the movement of the base 20 of the cylinder 14. The two chambers are kept sealingly separate by the cylinder 14 and the cylinder seal 13. The hydraulic system is used to pump the hydraulic fluid from one of these chambers and to fill the second so as to move the cylinder upwardly or downwardly in relation to the direction of pumping chosen by means of the manual valve 6.

To load the suspension, the upper flange of the column is removed by detaching the clamping ring 21a, and the column piston 11 is positioned at the base of the reservoir 9, the cylinder 14 being retracted downwardly to obtain a maximum available volume corresponding to the volume of the column 10 and reservoir 9 into which the suspension is poured. These two elements have the same inner diameter. The piston seals 12 ensure a seal at the walls and maintain the suspension in the volume corresponding to the reservoir 9 and column 10. With variable reservoir lengths it is possible to accommodate variable suspension volumes. Once the suspension is loaded, the bed packing step can be initiated as described below.

With the hydraulic system a column can be packed and also be unpacked after use. For column packing, the cylinder 14 is pushed by the hydraulic fluid compressed by the hydropneumatic pump 2. The hydropneumatic pump 2, as determined by choice of position of valve 6, directs the hydraulic fluid towards the chamber 16, which causes an upward movement of the cylinder 14. The reduced volume of chamber 17 leads to emptying of the fluid which is returned to the reservoir 4. The resulting difference in air volume in the reservoir 4 is offset by the vent 5 which allows air to escape or to enter in order to maintain atmospheric pressure in the reservoir 4.

A coupling cylinder 19 is fixedly mounted on the cylinder (by screwing for example) and receives the piston 11 in its upper part. The piston, initially placed on the coupling cylinder 19, pushes the suspension upwardly to form the bed by compression. The piston slides in the reservoir as far as inside the column. The piston 11 is not attached to the coupling cylinder 19. The piston 11 comprises seals 12 which prevent downward leakage of the column and reservoir content. Variable columns lengths and/or variable reservoirs can accommodate variable bed heights.

Clamping rings 21a, 21b, 21c are used to ensure joining of the column to the other elements of the modular system. The clamping rings 21a and 21b respectively ensure a seal between the upper flange and the column and between the column and the reservoir, by means of O-seals positioned between these elements.

Column packing rate is controlled in particular by the air flow rate of the regulator 1 feeding the hydropneumatic pump 2. The final pressure exerted on the bed is controlled by the air pressure set by the regulator which sets the pressure of the pump 2, and by the surface ratios between the piston 11 and the lower part 20 of the cylinder 14. For further details on the hydraulic part, reference can be made to document US-P-6001260.

The safety valve 7 limits the pressure exerted on the compressed medium forming the column bed. The tare of this valve is set at a hydraulic pressure equal to the maximum operating pressure for the packing medium multiplied by the surface ratio between the piston 11 and the lower part 20 of the cylinder 14.

According to the embodiment in FIG. 1, the cylinder is retractable, but it is not telescopic. It is not formed of several parts each sliding within one another to save space once retracted. Space savings are effectively unnecessary with the cylinder in the system of the invention. The hydraulic fluid pressure is therefore applied to the same surface of the cylinder throughout the entire packing phase, making it possible to maintain a constant force exerted on the piston and to have only one safety valve with only one pressure tare.

To unpack the column, the flange 15 is detached from the column 10 by removing the clamping ring 21a. The hydropneumatic pump 2 is actuated by an air intake controlled by the pressure regulator 1 by positioning the valve 6 so that the hydraulic fluid enters chamber 16 so as to repel the fluid into chamber 17 towards the reservoir. The particulate packing is extruded from the column 10 and collected at the top of the column, e.g. in a receptacle positioned at the column output.

After packing the column 10, the cylinder 14 and hence also the coupling cylinder 19, is retracted by turning the valve 6 so that this time the hydraulic fluid enters chamber 17 so as to repel the fluid in chamber 16 towards the reservoir. The piston 11 remains in place under the effect of friction forces exerted at the walls of column 10. However it is also possible to use a mechanical locking system if desired.

Once the column bed is in place, the column can be removed for its use in non-DAC chromatography, or it can be kept on the packing system for DAC use. For non-DAC use, the clamping ring 21b is removed. The column with the piston locked by friction and containing the packed chromatographic bed can be used as such for chromatography operations. In DAC use, the bed is maintained in the column between the piston and the flange. Since the piston is present in the column, the advantage is that only one single piston is used both to pack the chromatographic bed and to adjust the pressure of the bed during chromatographic separation.

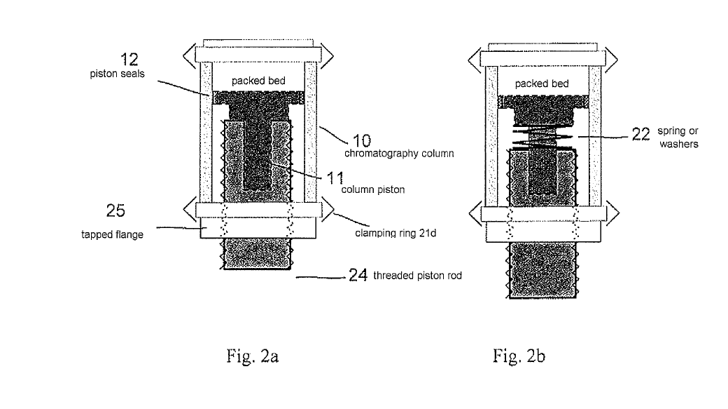

However, as illustrated FIG. 2a or 2b, it is preferred in the invention to place an assembly of a threaded rod 24 and tapped flange 25 receiving the threaded rod, said threaded rod adapting to the piston 11. The tapped flange receives the threaded rod 24 which comes into contact with the piston 11. The tapped flange 25 is secured to the column via a column flange and a clamping ring 21d. Therefore, according to one embodiment of the invention, the same attachment system via clamping rings is used for all the steps in which the device of the invention is used. In other embodiments, it is possible to use other securing systems, e.g. coupling by press-fitting, rotation and locking, etc. . . . A wrench can be used to offset any pressure drop throughout chromatography operations over time. The use of a lever or torque wrench allows clamping to be adjusted in relation to column bed characteristics. The anti-rotation device is able to reduce pull on the piston through rotation thereof. A spring e.g. of Belleville washer type 22 (FIG. 2b) can be arranged between the piston 11 and the threaded rod 24, so as to offset any pressure drop throughout chromatography operations over time.

The use of an intermediate removable reservoir 9 avoids having recourse to very long columns (as in the Modcole case for example). Shorter, and consequently less heavy, chromatography columns can be handled more easily. Since the reservoir can be available in several lengths, greater flexibility is achieved. Investment costs are thereby reduced. The intermediate reservoir 9 which is disconnected when the column 10 is in use, therefore allows for a shorter column. The column of the invention is a single unit column i.e. it comprises a single cylinder in which the piston slides and which contains the chromatographic bed; there are no elements which need to be successively mounted one on another.

The column 10 and the intermediate removable reservoir 9 are advantageously in stainless metal, stainless steel and the seals in PTFE, so that those parts of the device in contact with solvents or products are chemically stable and are fully compatible with regulatory requirements, in particular with pharmaceutical requirements. Also, the inner diameters can typically vary between 20 and 200 millimeters for column lengths of 50 to 600 millimeters, and reservoir lengths of 100 to 600 millimeters. The devices of the invention using columns of larger diameters preferably integrate assisted handling means.

The preferred securing by clamping rings provides for very easy and very swift use. Also, the risks related to screwing with the flanges of the prior art (Merck or Modcol) are avoided.

The use of a surface treatment prevents any seizing at the threaded rod and tapping, and avoids jamming risks.

The combined use of the anti-rotation assembly allows limited pull on the piston by rotation and hence provides control over the pressure exerted on the packed bed via the torque applied to the threaded rod.

Evidently packing systems can be used other than those described above as nonlimiting examples. It is possible for example to use an electric pump instead of the hydropneumatic pump 2. Similarly, it is possible to use en electric rather than a hydraulic cylinder in the base 8. The mechanical variants are within the reach of persons skilled in the art.

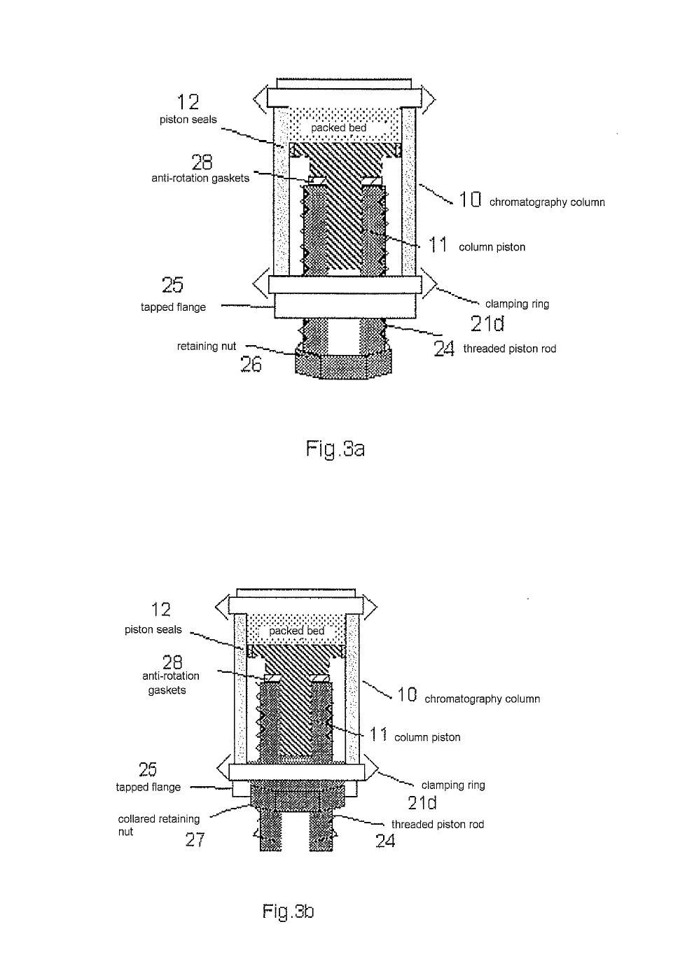

The invention also offers the advantage of control over the pressure exerted on the column bed in relation to the clamping torque of the retaining nut 26 positioned at the base of the threaded rod 24. By having recourse to a coating to prevent seizure it is possible to control the pressure exerted by the screw system, advantageously linear fashion. It is therefore possible to recompress the bed manually if necessary by tightening the threaded rod. This technical advantage is additionally independent of the general system of the invention, and can possibly be applied to any type of column. It is also possible to machine hexagonal sides on the screw used to clamp the piston onto the bed. It is also possible to install an anti-rotation gasket between the piston and the rod as a cylinder complement. According to one embodiment (FIG. 3a), the end of the threaded piston rod 24 is machined in the form of a retaining nut 26 (previously described with reference to FIG. 2a) so that it can receive a wrench; this wrench can be used to tighten the piston manually to offset any drop in packing pressure throughout chromatography operations over time; additionally, the use of a torque wrench can adjust clamping in relation to bed characteristics.

Preference may be given to an embodiment (FIG. 3b) having a loose nut with collar, machined in the form of a retaining nut 27 and inserted between the tapped flange 25 and the chromatography column 10; this nut slides on the base of the tapped flange 25 (the nut is mobile in rotation relative to the flange) carrying the piston with it when re-clamping; this nut is preferably in bronze or steel optionally coated with a non-seizure coating.

The advantage of the nut 26 or 27 is that it allows to bed to re-compacted at will and at any time; in particular the nut 26, 27 allows the bed to recompressed during the chromatography separation step.

According to one embodiment, a set of washers or an anti-rotation plate 28 can be positioned between the column piston 11 and threaded piston rod 24 to better promote axial movement of the bed when it is recompressed and also to better maintain a substantially linear relationship between the clamping torque applied to the retaining nut and the resulting pressure exerted on the packed bed.

Globally, the device of the invention is used as follows:
Once the column 10 and the intermediate removable reservoir 9 in position, the suspension can be poured.
The upper end of the column is closed by a flange 15 using a clamping ring attachment 21a;
Pressure is applied to the cylinder 14 which transmits the pressure to the piston 11 to compress the column bed. The piston is moved as far as inside the column, the piston being able to slide in the column.
Once bed packing pressure has been reached, the pressure on the cylinder 14 is released; the piston 11 remains in position in the column under the effect of friction or by means of a mechanical locking system.
The column is disconnected from the assembly by opening the clamping ring 21b attachment.
The threaded rod 24 and the tapped flange 25 are then placed on the column 10 and secured via a clamping ring 21d (clamping rings 21a, 21b, 21c and 21d advantageously being identical) and the pressure applied to the bed is controlled in relation to the clamping torque.
The column 10 is then ready for use as a chromatography column.

When pressure at the piston is released, slight expansion of the bed may occur. Recompressing of the bed may be advisable, either before or during the chromatography operations. It is possible to (re)compress the bed, in particular to eliminate voids and channeling which may occur in the bed and/or to maintain the efficacy of the column (efficiency, asymmetry, number of theoretical plateaus, peak symmetry):
either by using a spring of Belleville washer type 22 as indicated above with reference to FIG. 2b;
or using the threaded rod 24 and applying a torque using a wrench which can adapt to the threaded rod which ends in the form of a nut 26 for example;
or by replacing the column on the base and recommencing a column packing cycle.

The system according to the invention is rapid: after pouring the homogeneous suspension into the column and reservoir, the time required to close the device and pack the bed is in the order of one minute, allowing any sedimentation in the column to be avoided which is detrimental to the arrangement of the particulate bed during the packing step. This is also of particular advantage when several columns need to be used (SMB, Varicol®), by reducing the preparation time of the separation process.

Since the packing method is rapid, it is generally not necessary to agitate the suspension in the column before packing. In general, there is no need either to re-fluidize the suspension in the reservoir.

The invention therefore provides one or more of the following advantages:
The device uses a single unit column i.e. which does not need to be coupled with adjustment units (contrary to the Amicon system for example).
The device is flexible and can be used in “DAC” mode whilst maintaining the column mounted on the packing module, and in “non DAC” mode according to the described operating mode with different bed heights.
In “non-DAC” mode the device allows performance levels to be reached which are close to DAC systems, in particular in terms of reproducibility.
Investment and operating costs are reduced.
Operating procedures are fast and easy, thereby reducing risks of improper handling.
The volume of the column required to contain the initial suspension volume is no longer related to the chromatography column but to the removable reservoir.
There is no need to mount the packing device: the hydraulic device associated with the base is compact and ready for use once the reservoir of hydraulic fluid is filled and the air purged.
The design is modular. The intermediate removable reservoir is placed between the base and the column and is dedicated to the initial suspension; it is then removed from the column. It can be sized in relation to the volume of suspension, and can be available in different lengths.
The attachment system by clamping ring eliminates the need for screwing the flanges and therefore avoids poor securing and improves assembly time.
A non-seizure coating on the threaded rod and tapping avoids jamming and allows the applied pressure to be controlled in relation to the torque applied to the threaded rod. The invention provides the possibility to adjust pressure linear fashion in relation to the torque applied to the piston.
All the parts of the device in contact with solvents and products to be separated are in stainless steel or PTFE, providing compatibility with conventional chromatography solvents.
The method is fast and simple.
The method is a simple method to maintain satisfactory bed stability over time (and hence a constant separating capacity of the column).

The column 10 can be used on all systems, in particular on a Simulated Moving Bed—SMB system (U.S. Pat. No. 2,985,589, U.S. Pat. No. 3,291,726, U.S. Pat. No. 3,268,605 and U.S. Pat. No. 3,266,604 held by UOP, U.S. Pat. No. 5,578,215 and U.S. Pat. No. 5,578,216 held by IFP and NOVASEP, EP 471 082 and EP 563 388 held by DAICEL) or on a VARICOL system (U.S. Pat. No. 6,136,198). Said systems use an assembly of these columns arranged in a loop. The column 10 can also be used for batch chromatography methods or with the CYCLOJET system (U.S. Pat. No. 6,063,284 and U.S. Pat. No. 5,630,943).

Although the described embodiment refers to a bottom-to-top direction, the invention can also be applied with a top-to-bottom direction. The component parts are then reversed, the reservoir is fixed to the bottom part of the packing system, then the column is attached below using a clamping ring attachment. The reservoir and column are then filled with the particle suspension and the bed is packed. After this operation the column is detached from the reservoir, and the column is prepared as described previously.

1. Chromatography device comprising:
a single unit column intended to receive a chromatographic bed,
a removable reservoir for bed suspension,
a base comprising a cylinder adapted to a piston, said piston sliding in the removable reservoir and the column to pack the suspension of solid particles into a chromatographic bed,
the column, reservoir and base being connected in series in this order, the piston acting to compress the suspension of solid particles into a chromatographic bed in the column.

2. Device according to claim 1, wherein the column, reservoir and base are connected from top to bottom.

3. Device according to claim 1 or 2, wherein the piston is equipped with a piston seal entering with friction into the column and reservoir.

4. Device according to any of claims 1 to 3, wherein the piston and the cylinder are connected by a coupling cylinder reversibly bearing upon the piston.

5. Device according to any of claims 1 to 4, wherein the column, reservoir and base are secured at flanges by means of clamping rings.

6. Device according to any of claims 1 to 5, wherein the base comprises two chambers receiving a pressurized hydraulic fluid, arranged at each side of the lower part of the cylinder.

7. Device according to any of claims 1 to 6, wherein the column also comprises an assembly of a threaded rod and tapped flange receiving the threaded rod, said threaded rod adapting to the piston, this assembly substituting for the reservoir when the column is used as chromatography column.

8. Device according to claim 7, wherein, in the assembly, the threaded rod is provided with a retaining nut to adjust the compressive force of the bed.

9. Device according to claim 7 or 8, wherein the threads of the rod and tapping have an anti-seizure coating.

10. Device according to any of claims 7 to 9, wherein an anti-rotation gasket is placed between the piston and the rod.

11. Device according to any of claims 7 to 9, wherein there is a spring between said threaded rod and the piston.

12. Chromatography column comprising an assembly of a threaded rod and tapped flange receiving said threaded rod, said threaded rod adapting to the piston, this assembly being attached to the column via a clamping ring.

13. Chromatography column according to claim 12, wherein the threads of the rod and tapping have an anti-seizure coating.

14. Chromatography column according to claim 12 or 13, wherein there is a spring between said threaded rod and the piston.

15. Chromatography column comprising an assembly of a threaded rod and tapped flange receiving the threaded rod, said threaded rod adapting to the piston, this assembly being secured to the column, and wherein the threads of the rod and tapping have an anti-seizure coating.

16. Column according to claim 15, wherein there is a spring between said threaded rod and the piston.

17. Column according to any of claims 12 to 16, wherein, in the assembly, the rod is provided with a retaining nut.

18. Packing method to pack a chromatographic bed in a chromatography column comprising the following steps:
providing a device according to any of claims 1 to 6;
filling this device with a bed suspension;
causing translation of the cylinder and piston to compress the suspension into a bed.

19. Method according to claim 18, also comprising the following step:
detaching the column from the reservoir.

20. Method according to claim 19, also comprising the following step:
associating the assembly of the threaded rod and tapped flange receiving the threaded rod, said threaded rod adapting to the piston.

21. Method according to claim 20, wherein, in the assembly, the threads of the rod and tapping have an anti-seizure coating.

22. Method according to claim 21, wherein, in the assembly, the rod is provided with a retaining nut.

23. Method according to any of claims 20 to 22, wherein, in the assembly, there is a spring between said threaded rod and the piston.

24. Method according to any of claims 19 to 23, also comprising a recompression step by clamping the threaded rod.

25. Method according to claim 24, wherein the pressure exerted on the compressed bed is controlled by the clamping torque applied to the nut.

26. Method to separate at least two compounds from a fluid to be chromatographied, comprising chromatography of said fluid in the column according to any of claims 12 to 17.

27. Method to separate at least two compounds from a fluid to be chromatographied, comprising the steps of packing the bed according to any of claims 18 to 25, and causing flow of the fluid to be chromatographied through the bed, and collection thereof.
